(19) United States
(12) Patent Application Publication
(10) Pub. No.: US 2014/0286029 A1
(43) Pub. Date: Sep. 25, 2014

(54) LIGHTING DEVICE FOR A VEHICLE INTERIOR

(71) Applicant: Wolfgang Mueller, Wermelskirchen (DE)

(72) Inventor: Wolfgang Mueller, Wermelskirchen (DE)

(73) Assignee: Johnson Controls GmbH & Co. KG, Grefrath (DE)

(21) Appl. No.: 14/119,476

(22) PCT Filed: May 24, 2012
(86) PCT No.: PCT/EP2012/059713

§ 371 Date: May 29, 2014

(30) Foreign Application Priority Data
May 24, 2011 (DE) 10 2011 103 022.4

(51) Int. Cl. F21S 8/10

(52) U.S. Cl. CPC F21S 48/00
USPC 362/511

(57) ABSTRACT

The invention relates to a lighting device (1) for a vehicle interior, comprising a light guide element (4) having a light coupling surface and a light decoupling surface, wherein a luminous flux can be introduced into the light coupling surface by means of at least one light source, wherein the light guide element (4) is retained at least in some sections in a frame element (2) at the edges thereof. According to the invention, the at least one light source is arranged in the frame element (2) in such a way that the light decoupling surface (13) extends substantially perpendicularly to the light coupling surface, wherein the light guide element (4) is structured at least in some sections.

### BACKGROUND OF THE INVENTION

The invention relates to a lighting device for a vehicle interior.

Conventional lighting devices in the roof area of a vehicle use incandescent bulbs as a lighting means. In this case, the luminous flux from the incandescent bulb is distributed by means of a reflector and a diffusing panel such that the desired illumination of the vehicle interior is achieved.

Furthermore, lighting devices are known which use light-emitting diodes as a light source and likewise distribute the luminous flux therefrom by means of reflector and diffusing panel. Such a lighting device is known, for example, from WO 2010/112191 A1, EP 1 270 331 A1 and DE 103 15 251 A1.

### SUMMARY OF THE INVENTION

The present invention provides, in one aspect, a lighting device for a vehicle interior including a light guide element having a light input surface and a light output surface. A luminous flux can be introduced into the light input surface by means of at least one light source. The light guide element is held at the edge in a frame element, at least in some sections. The at least one light source is arranged in the frame element in such a way that the light output surface extends substantially perpendicular to the light input surface. The light guide element is also structured, at least in some sections.

The object of the present invention is to specify an improved lighting device for a vehicle interior.

According to the invention, the object is achieved by a lighting device for a vehicle interior which comprises a flat and/or plate-like light guide element, into which a luminous flux can be introduced at least one end by means of at least one light-emitting diode, wherein the light guide element is held at the edge in a frame element, at least in some sections, in which at least one light-emitting diode and/or at least one switching element are arranged. A surface of the light guide element located opposite the vehicle interior is formed as a light deflection surface, and a surface of the light guide element facing the vehicle interior is formed as a light output surface. The light deflection surface is preferably structured, at least in some sections, for example provided with prisms, lenses, a defined roughness and/or printing.

Furthermore, the light output surface extends substantially perpendicular to the light input surface.

In a possible embodiment, the surface of the light guide element, and in particular the surface of the light output surface, has a defined roughness, preferably in a range of 90% to 100% of the total area. As a result of forming the surface with a rough structure, a uniform distribution of light is possible.

Alternatively or additionally, the light guide element can also be provided with internal scattering means, which likewise permit a uniform distribution of the luminous flux in the light guide element and a uniform emission of the luminous flux into the vehicle interior.

A further embodiment provides that, for a particularly uniform light distribution, the lighting device comprises optical elements, in particular prisms and/or lenses, or the light output surface is printed.

Switching elements for operating the lighting device can be arranged on or integrated in the frame element.

Advantageously, the necessary installation space for the lighting device is minimized, which means that, in particular for the vehicle interior, the result is a higher stylistic freedom in the arrangement and formation of the lighting device. For this purpose, the lighting device is designed to be flat and/or plate-like and preferably has a thickness of less than 10 mm, particularly preferably less than 5 mm.

A development of the invention provides for the frame element to surround the light guide element completely and for the light source to be arranged on at least one side edge of the light guide element in the frame element. This permits a particularly compact and flat design of the lighting device.

Preferably, the frame element and the light guide element embraced by the latter are formed as a covering element. The covering element is pivotably mounted and, to this end, expediently has a hinge on at least one side edge.

In order to operate the lighting device, the latter preferably has at least one switching element. In one possible embodiment, the switching element is arranged on or integrated in the frame element. Alternatively, the light guide element itself can be formed as a switch-sensitive element.

In particular, by means of the light guide element, even when light-emitting diodes having a high luminous flux are used, it is possible to generate a uniform light distribution without glare for the occupants of the vehicle. In this case, the luminous flux from the light-emitting diodes is understood to mean a brightness of the light emitted by the light-emitting diode that can be perceived by the human eye.

As a result of the particularly flat design with a thickness of less than 10 mm, in particular of less than 5 mm, of the lighting device according to the invention, pressing into a corresponding recess in a carrier of the vehicle, for example a conventional roof lining, is possible, so that a conventional cut-out in the carrier is dispensed with.

Thus, the lighting device according to the invention can be matched in a particularly simple way to the flat contours of the roof lining or integrated in the latter.

In an advantageous embodiment, a stowage compartment can be arranged behind the lighting device according to the invention, the installation depth of which is reduced significantly in comparison with conventional lighting devices. Here, the light guide element and the frame element thereof can be configured as a covering element which covers the stowage compartment.

By means of the use of non-contact switches to switch the lighting device, advantageous design variants in the vehicle interior are possible. For example, the light guide element itself can serve as a switch-sensitive surface.

Exemplary embodiments of the invention will be explained in more detail below by using drawings.

### BRIEF DESCRIPTION OF THE DRAWINGS

FIG. 1 shows, schematically, a perspective view of a lighting device for a vehicle interior with switching elements arranged in the frame element,

FIG. 2 shows, schematically, a side view of a lighting device for a vehicle interior,

FIG. 3 shows, schematically, a side view of a lighting device formed as a covering element for a vehicle interior, wherein the covering element is located in a closed position, and

FIG. 4 shows, schematically, a side view of a lighting device formed as a covering element for a vehicle interior, wherein the covering element is located in an opened position.

Mutually corresponding parts are provided with the same designations in all the drawings.

### DETAILED DESCRIPTION

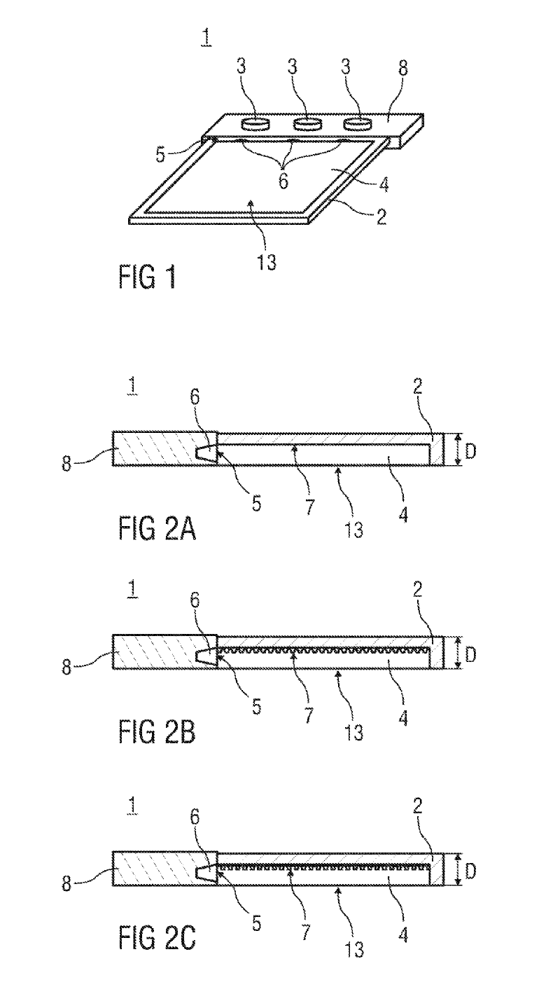

In FIG. 1, a perspective view of a lighting device 1 for a vehicle interior, not shown, having switching elements 3 arranged in the frame element 2, is shown schematically.

The lighting device 1 permits the use of light-emitting diodes having a high luminous flux to illuminate the vehicle interior, in particular a uniform light distribution without glare being generated for the occupants of the vehicle. For this purpose, the lighting device 1 comprises at least one light guide element 4 and the frame element 2.

The light guide element 4 is flat and/or plate-like and, for example, formed as a plastic plate or plastic panel. Here, the plastic panel is designed to be transparent.

At least one end 5 of the light guide element 4, the light input surface, a luminous flux from a light source is introduced. The light source used is, in particular, at least one conventional light-emitting diode 6. The luminous flux from the light-emitting diode 6 is propagated uniformly in the light guide element 4, it being possible for this uniform propagation in the light guide element 4 to be assisted or improved by means of an appropriate surface structure or roughness or scattering means, not illustrated.

In design variants that are not illustrated, a luminous flux from at least one conventional light-emitting diode 6 can be introduced respectively at several ends or all ends 5 of the light guide element 4.

In a preferred embodiment, a plurality of light-emitting diodes 6 can be arranged at one end 5.

The light-emitting diode or the light-emitting diodes 6 is an electronic semiconductor component and thus a substantially maintenance-free lighting means with a particularly long service life.

In order to radiate the luminous flux from the light guide element 4 in the direction of the vehicle interior, a surface 7 of the light guide element 4 opposite the vehicle interior is formed as a light deflection surface, and a surface that faces the vehicle interior is formed as a light output surface 13. The light deflection surface 7 is preferably structured, for example provided with prisms, lenses, a defined roughness and/or printing, for example with a light and/or white dot-like pattern. FIGS. 2A to 2C show various embodiments for structuring the surface 7 of the light guide element 4 serving as a light deflection surface. This surface structuring permits a particularly uniform and glare-free emission of luminous flux into the vehicle interior.

The light output surface 13 is designed to be substantially flat and smooth. The light guide element 4 is held in a frame element 2 at the edge, at least in some sections.

In a preferred design variant, the frame element 2 is arranged to encircle the light guide element 4 completely at the edge. In this case, the frame element 2 is preferably fabricated from an opaque plastic.

The frame element 2 imparts additional stability to the lighting device 1 and prevents an undesired lateral escape of the luminous flux at the ends 5 of the lighting device 1.

Although not specifically illustrated, holding means for the arrangement of the light-emitting diodes 6 are introduced in the frame element 2, the light-emitting diodes 6 being aimed with their main emission direction at one of the ends 5 of the light guide element 4. The light output surface 13 thus extends substantially perpendicular to the light input surface.

In a further preferred design variant, the frame element 2 can be expanded with an operating section 8, in which there is arranged at least one switching element 3. The switching elements 3 are formed as conventional switching elements, for example pushbuttons, and permit operation of the lighting device 1.

The frame element 2 and the operating section 8 are preferably formed in one piece and form an integrated structural unit.

In a design variant that is not illustrated, switching elements 3 acting without contact can be used; as a result of the use of non-contact switching elements 3 to switch the light guide element 4, advantageous design variants in the vehicle interior are possible. For example, the light guide element 4 itself can serve as a switch-sensitive surface.

In FIG. 2, a side view of the lighting device 1 for a vehicle interior is illustrated schematically. The lighting device 1 according to the invention advantageously has a thickness D of less than 10 mm; the thickness D is preferably less than 5 mm.

As a result of this particularly flat design of the lighting device 1 according to the invention, pressing into a corresponding recess in a carrier on the vehicle, for example a conventional roof lining, is sufficient, so that a conventional cut-out in the carrier can be dispensed with.

Thus, the necessary installation space for the lighting device 1 is minimized, which means that, in particular for the vehicle interior, the result is a higher stylistic freedom in the arrangement and formation of the lighting device 1.

As a result, the lighting device 1 can be matched in a particularly simple way to the flat contours of a conventional roof lining, in particular in a vehicle front panel arranged at a shallow angle, or integrated in the latter.

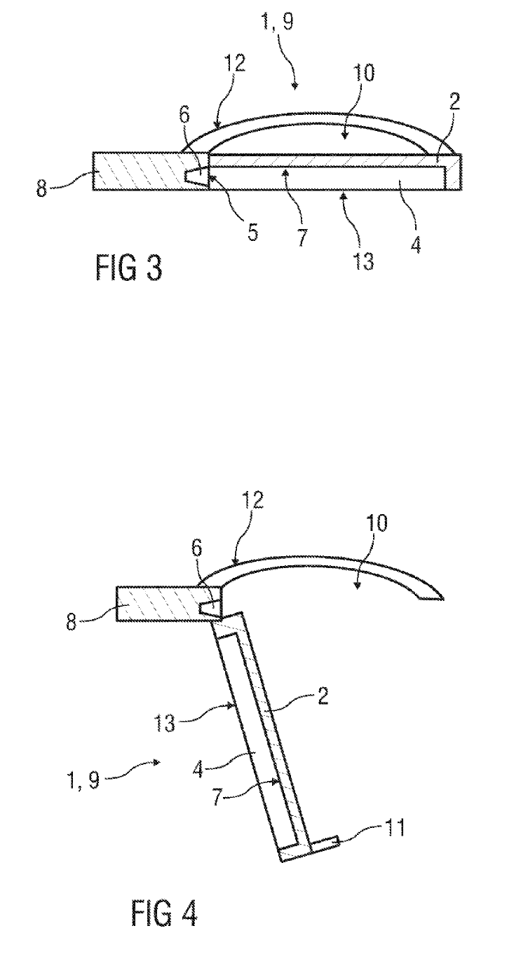

A side view of a lighting device 1 for a vehicle interior that is formed as a covering element 9 is illustrated schematically in FIG. 3, wherein the covering element 9 is located in a closed position.

As a result of this particularly flat design of the lighting device 1 according to the invention, a stowage compartment 10 can be arranged in an installation space at the rear of the lighting device 1. This is possible as a result of the significantly reduced installation depth of the lighting device 1 in comparison with conventional lighting devices. Here, the light guide element 4 and the frame element 2 thereof are configured as a pivotable covering element 9, which covers the stowage compartment 10 behind the lighting device 1. As a result of arranging the lighting device 1 in the pivotable covering element 9 of the stowage compartment 10, this area can be used for a plurality of functions (lighting and covering). This permits a compact and area-saving design.

The covering element 9 is fixed pivotably to the frame 8 by means of a conventional hinge, not shown, said frame having been expanded here by a rear covering 12 of the stowage compartment 10. In the closed position, the covering element 9 is held in a vibration-proof and shake-proof manner by means of a conventional detachable closure means 11, for example a latching connection, a locking mechanism or a magnetic catch.

A side view of a lighting device 1 formed as a covering element 9 for a vehicle interior is illustrated schematically in FIG. 4, wherein the covering element 9 is in an opened position. Here, the covering element 9 has been pivoted in the direction of the vehicle interior by means of the conventional hinge, not shown, following the release of the closure means 11, so that access to the stowage compartment 10 is possible.

Various features of the invention are set forth in the following claims.

1. A lighting device for a vehicle interior, comprising;
a light guide element having a light input surface and a light output surface, wherein a luminous flux can be introduced into the light input surface by at least one light source, wherein
the light guide element is held at the edge in a frame element, at least in some sections, wherein
the at least one light source is arranged in the frame element in such a way that the light output surface extends substantially perpendicular to the light input surface, and wherein
the light guide element is structured, at least in some sections.

2. The lighting device as claimed in claim 1,
wherein the light guide element is made of plastic and a surface of the light guide element is formed as a light deflection surface and has a defined roughness of 90% to 100% of the total area.

3. The lighting device as claimed in claim 1,
wherein the light guide element is made of plastic and a surface of the light guide element is formed as a light deflection surface and is printed.

4. The lighting device as claimed in claim 1,
wherein the light guide element is made of plastic and a surface of the light guide element is formed as a light deflection surface and is provided with at least one optical element, in particular at least one of a prism and a lens.

5. The lighting device as claimed in claim 1,
wherein the light guide element is made of plastic and is provided with internal scattering means.

6. The lighting device as claimed in claim 1,
wherein the light guide element is made of plastic and is one of flat and plate-like.

7. The lighting device as claimed in claim 1,
wherein the frame element surrounds the light guide element completely, and the light source is arranged on at least one side edge of the light guide element in the frame element.

8. The lighting device as claimed in claim 1,
wherein the frame element and the light guide element embraced by the latter are formed as a covering element.

9. The lighting device as claimed in claim 7,
wherein the covering element is pivotably mounted.

10. The lighting device as claimed in claim 1,
wherein the light guide element is formed as a switch-sensitive element.

11. The lighting device as claimed in claim 1,
wherein at least one switching element for operating the lighting device is arranged on or integrated in the frame element.

12. The lighting device as claimed in claim 1,
wherein the light source is formed as a light-emitting diode.

13. The lighting device as claimed in claim 1,
wherein the lighting device has a thickness of less than 10 mm, in particular less than 5 mm.

14. A stowage compartment having a lighting device as claimed in claim 1 pivotably mounted thereon, which serves as a covering.

15. A roof lining having a lighting device as claimed in claim 1.

16. The lighting device as claimed in claim 2,
wherein the light guide element is made of plastic and a surface of the light guide element is formed as a light deflection surface and is printed.

17. The stowage compartment as claimed in claim 14, wherein the light guide element is made of plastic and a surface of the light guide element is formed as a light deflection surface and is printed.

18. The stowage compartment as claimed in claim 14, wherein the light guide element is made of plastic and a surface of the light guide element is formed as a light deflection surface and is provided with at least one optical element, in particular at least one of a prism and a lens.

19. The roof as claimed in claim 15, wherein the light guide element is made of plastic and a surface of the light guide element is formed as a light deflection surface and is printed.

20. The roof as claimed in claim 15, wherein the light guide element is made of plastic and a surface of the light guide element is formed as a light deflection surface and is provided with at least one optical element, in particular at least one of a prism and a lens.
